(19) United States
(12) Patent Application Publication
(10) Pub. No.: US 2022/0391487 A1
(43) Pub. Date: Dec. 8, 2022

(54) Method of Authenticating the Identity of a User Wearing a Wearable Device

(71) Applicant: Prevayl Innovations Limited, Manchester, Greater Manchester (GB)

(72) Inventor: Tahir Mahmood, Manchester, Greater Manchester (GB)

(21) Appl. No.: 17/773,978

(22) PCT Filed: Nov. 13, 2020
(86) PCT No.: PCT/GB2020/052898

§ 371 Date: May 3, 2022

(30) Foreign Application Priority Data
Nov. 15, 2019 (GB) 1916671.9

(51) Int. Cl. G06F 21/40; G06F 1/16

(52) U.S. Cl. CPC G06F 21/40; G06F 1/163

(57) ABSTRACT

The method comprises obtaining a first source of authentication information for the user comprising a feature set extracted from biometric data sensed by sensors of the wearable device (S101). The extracted feature set is input into a recognition algorithm which uses the extracted feature set and predetermined feature set representing an authorised user that is authorised to use the wearable device, and generates a confidence level indicating the likelihood that the user wearing the wearable device is the authorised user (S102). A second source of authentication information is obtained from the user (S103). The method identifies, from the second source of authentication information, whether the user is authorised to use the wearable device (S104). If the user is authorised, the method authenticates the identity of the user wearing the wearable device as corresponding to the authorised user (S105).

### CROSS-REFERENCE TO RELATED APPLICATIONS

This application claims priority from United Kingdom Patent Application number 1916671.9 filed on 15 Nov. 2019, the whole contents of which are incorporated herein by reference.

### BACKGROUND

The present disclosure is directed towards a computer-implemented method, computer apparatus, system and electronic device for recognising whether a user has a preset property. In examples, this is used in authenticating the identity of a user wearing a wearable device.

Wearable devices comprise sensors which are able to measure the physiological and behavioural traits of a user wearing the wearable device. Wearable devices are able to be used to perform biometric authentication procedures to verify the identity of the user wearing the wearable device or identify the user wearing the wearable device from a list of potential pre-registered users. Wearable devices provide advantages over traditional biometric devices such as fingerprints, eye features, or voice signal recognition systems incorporated into electronic devices. One advantage is that as wearable devices are constantly worn, they can provide a continuous authentication of the user without requiring any conscious input from the user. Wearable devices are also used to provide sensor data for use in other forms of recognition algorithms for recognising whether the user has a pre-set property. For example, the recognition algorithm may be arranged to recognise whether the user is fatigued, performing a certain activity like running or walking, dehydrated, or at risk of a medical emergency such as a heart attack.

A problem with wearable devices is that due to size, battery and cost constraints, the sensors used to sense the signals are usually cheaper and have less accuracy than traditional devices. A consequence of this is that the sensor readings tend to have more noise than traditional devices. This affects the outputs of the recognition algorithms whether used for biometric authentication procedures or other recognition procedures as disclosed above. Moreover, the type of biometric signal sensed by wearable devices (e.g. electrocardiography) are more susceptible to natural changes in the user's state. This generally leads to wearable devices being less accurate sources of biometric data for biometric authentication than traditional biometric devices.

It is an object of the present disclosure is to provide an improved approach for authenticating the identity of a user wearing a wearable device.

It is an object of the present disclosure is to provide an improved approach for recognising whether a user has a pre-set property using recognition algorithms.

### SUMMARY

According to the present disclosure there is provided a computer-implemented method, computer program, computer-readable medium, computer apparatus, system, and electronic device as set forth in the appended claims. Other features of the invention will be apparent from the dependent claims, and the description which follows.

According to a first aspect of the disclosure, there is provided a computer-implemented method of authenticating the identity of a user wearing a wearable device. The method comprises the following steps: (a) obtaining a first source of authentication information for a user wearing the wearable device; (b) inputting the first source of authentication information into a recognition algorithm which uses the first source of authentication information and predetermined authentication information representing an authorised user that is authorised to use the wearable device, and generates a confidence level indicating the likelihood that the user wearing the wearable device is the authorised user; (c) obtaining a second source of authentication information from the user of the wearable device; and (d) identifying, from the second source of authentication information, whether the user is authorised to use the wearable device.

Beneficially, the present disclosure provides a method that uses two sources of authentication information to determine whether a user is authorised to use the wearable device. The first source of authentication information may comprise biometric data sensed by one or more sensors of the wearable device. Wearable devices comprise sensors to measure biometric data. The biometric data may be derived from electrocardiography (ECG) or photoplethysmography (PPG) data amongst others.

A benefit of wearable devices is that they provide a convenient mechanism for collecting biometric data from a user. The wearable devices can obtain the biometric data automatically without requiring any input from the user. Moreover, when the wearable devices are worn, they can constantly or intermittently sense biometric data. A problem with wearable devices, however, is that the biometric data obtained may be a less reliable source of authentication information than traditional methods of biometric authentication such as fingerprint recognition. One reason for this is that wearable devices typically require smaller, less powerful electronics components compared to standalone biometric readers. Another reason is that the obtained biometric data may be affected by poor sensor contact or bad/sub-optimal placement of the wearable device by the user. Furthermore, some biometrics recorded by wearable devices may be unreliable if the user is in a heightened emotional state or energy level. Advantageously, by obtaining the second source of authentication information from the user, the present disclosure performs a secondary authentication check. This enables the use of the wearable device by an authorised user even if the biometric authentication procedure using the first authentication information fails.

The first source of authentication information may comprise a feature set extracted from the biometric data sensed by the one or more sensors of the wearable device. The recognition algorithm may use the extracted feature set and a predetermined feature set representing an authorised user that is authorised to use the wearable device.

The method may further comprise (e) if the user is identified as being authorised to use the wearable device from the second source of authentication information, authenticating the identity of the user wearing the wearable device as corresponding to the authorised user.

The method may further comprise (e) if the user is identified as being authorised to use the wearable device from the first source of authentication information and the second source of authentication information, authenticating the identity of the user wearing the wearable device.

The recognition algorithm may further comprise determining if the confidence level is greater than or equal to the predetermined threshold, and wherein steps (c) to (d) are performed if the generated confidence level is less than the predetermined threshold. Advantageously, the present disclosure may only perform the secondary check using the second authentication information if the confidence level is less than a predetermined threshold level. This means that if the check using biometric information sensed by the wearable device fails, the user is still able to use the wearable device based on the secondary check using second authentication information. Steps (c) to (d) may be performed if the generated confidence level is less than a first predetermined threshold and greater than a second predetermined threshold. This may mean that the second authentication procedure is only performed if the confidence level is less than but close to the first predetermined threshold. The second authentication procedure may only be performed in borderline cases rather than cases where, from the first authentication procedure, the user wearing the wearable device is clearly not the same as the authorised user. The first predetermined threshold may be 90%, 80%, 70%, or 60%. The second predetermined threshold may be 80%, 70%, 60%, or 50%.

The recognition algorithm may further comprise determining if the confidence level is greater than or equal to the predetermined threshold, and wherein steps (c) to (e) are performed if the generated confidence level is less than the predetermined threshold.

Additional algorithms may be used subsequently to determine whether the other algorithms are able to give a better approximation than the recognition algorithm. The present disclosure may use the output from multiple recognition algorithms to determine an overall confidence level such as by performing an averaging operation.

Step (e) may further comprise updating the recognition algorithm to reflect that the first source of authentication information (e.g. the extracted feature set) is associated with the authorised user if the user is identified as being authorised to use the wearable device from the second source of authentication information. In some instances, an extracted feature set may represent an authorised user (e.g. because it was extracted from the authorised user's biometric data) but the recognition algorithm is unable to correctly identify the user from the extracted feature set. For example, the recognition algorithm may comprise a machine-learned model which was trained on training data obtained from the user under a certain physiological condition (e.g. a rest state). The machine-learned model may be unable to recognise the user under other physiological conditions. In other examples, the user's biometric identity measured under some metrics such as ECG may naturally change with age such that a recognition algorithm developed to recognise a user at a first time point may be unable to successfully recognise the same user at a second, later, time point. By updating the recognition algorithm according to the present disclosure, the present disclosure is able to enhance and improve the recognition algorithm as new and unexpected biometric data is obtained from the authorised user. If time series analyse is used, then the current signal may be useable to estimate a past state or even predict a future state for the user.

Updating the recognition algorithm may comprise indicating to the recognition algorithm that the first source of authentication information (e.g. the extracted feature set) is associated with the authorised user. The indicating may comprise adding the extracted feature set to a list of predetermined feature sets associated with the authorised user. The indicating may comprise replacing the predetermined feature set with the extracted feature set such that in subsequent iterations of the recognition algorithm, the recognition algorithm uses the extracted feature set. The indicating may comprise generating an updated feature set using a combination of the extracted feature set and the predetermined feature set.

The recognition algorithm may further comprises determining if the confidence level is greater than or equal to the predetermined threshold. Updating the recognition algorithm may further comprises modifying the predetermined threshold.

The recognition algorithm may input the extracted feature set to a machine-learned model which outputs the confidence level. The machine-learned model may be trained using training data comprising the predetermined feature set. Updating the recognition algorithm may further comprise training the machine-learned model using training data comprises the extracted feature set.

Training the machine-learned model may comprise re-training the machine-learned model. Training the machine-learned model may comprises updating the machine-learned model. Updating the machine-learned model may comprise modifying one or more weights of the machine-learned model.

Step (c) may comprise prompting the user of the wearable device to provide the second source of authentication information. Prompting may comprise transmitting a request for the second source of authentication information to the wearable device or electronic device.

The method may further comprise obtaining an identifier for the wearable device. The recognition algorithm may use a predetermined feature set representing a user that is authorised to use the wearable device identified by the identifier. The predetermined feature set or a machine-learned model trained using training data comprising the predetermined feature set may be linked to the identifier in a database. The method may comprise using the identifier to access the predetermined feature set or machine-learned model stored in the database.

The recognition algorithm may use a plurality of predetermined feature sets representing a plurality of users that are authorised to use the wearable device. The recognition algorithm may generate a plurality of confidence levels each indicating the likelihood that the user wearing the wearable device is one the authorised users.

The second source of authentication information may be obtained from a separate device to the wearable device. The separate device may be a user electronic device.

The second source of authentication information may be derived from one or more of a passcode, password, fingerprint ID, face ID, gesture, or user input received via the wearable device or another electronic device. The second source of authentication information may be from another, different, validated user.

Obtaining the first source of authentication information may comprise receiving the first source of authentication information from the wearable device. Obtaining the first source of authentication information may comprise extracting the feature set from biometric data sensed by the wearable device.

The method may be performed by the wearable device. The method may be performed by an electronic device in communication with the wearable device such as a mobile phone. The method may be performed by a server in communication with the wearable device either directly or via an electronic device.

In implementations where the method is performed by the wearable device, the wearable device may transmit a secure token to an external device such as a mobile phone or server if the user is determined to be authorised. If the wearable device is unable to authenticate the user from the first authentication procedure, the wearable device may request authentication information either directly or by communicating with an external device such as a phone.

According to a second aspect of the disclosure, there is provided a computer apparatus. The computer apparatus comprises a first obtaining module arranged to obtain first source of authentication information for a user wearing the wearable device. The computer apparatus comprises a recognition module arranged to input the first source of authentication information into a recognition algorithm which uses the first source of authentication information and predetermined authentication information representing an authorised user that is authorised to use the wearable device, and generates a confidence level indicating the likelihood that the user wearing the wearable device is the authorised user. The computer apparatus further comprises a second obtaining module arranged to: obtain a second source of authentication information from the user of the wearable device; and identify, from the second source of authentication information, whether the user is authorised to use the wearable device.

The first source of authentication information may comprise a feature set extracted from biometric data sensed by one or more sensors of the wearable device. The recognition algorithm may use the extracted feature set and a predetermined feature set representing an authorised user that is authorised to use the wearable device.

If the user is identified as being authorised to use the wearable device from the second source of authentication information, the second obtaining module is arranged to authenticate the identity of the user wearing the wearable device as corresponding to the authorised user.

According to a third aspect of the disclosure, there is provided a system. The system comprises a wearable device. The system comprises a computer apparatus of the second aspect of the disclosure. The wearable device is arranged to transmit a first source of authentication information to the computer apparatus. The first source of authentication information may comprise a feature set extracted from biometric data sensed by one or more sensors of the wearable device.

According to a fourth aspect of the disclosure, there is provided an electronic device. The electronic device comprises a communicator arranged to communicate with a wearable device. The electronic device comprises a controller operable to control the communicator. The controller is operable to: control the communicator to receive, from the wearable device, a first source of authentication information for a user wearing the wearable device; obtain a second source of authentication information from the user of the wearable device; and control the communicator to transmit the first source of authentication information, and the second source of authentication information to a server.

The controller may further be operable to control the communicator to receive, from the wearable device, a first identifier for the wearable device. The controller may be operable to control the communicator to transmit the identifier to the server. The identifier may be transmitted in a data packet comprising the first and second source of authentication information.

According to a fifth aspect of the disclosure, there is provided a computer-implemented method of updating a recognition algorithm. The method comprises the following steps: (a) obtaining a representation of sensor data sensed by one or more sensors of a wearable device; (b) performing a recognition procedure to recognise whether the user wearing the wearable device has a pre-set property, the recognition procedure comprises inputting the representation of the sensor data to a recognition algorithm which uses the representation and a representation determined to be associated with the pre-set property to generate a confidence level indicating the likelihood of the user having the pre-set property; (c) obtain verification information from the user to verify that the user has the pre-set property; and (d) if the verification information verifies that the user has the pre-set property, updating the recognition algorithm to reflect that the representation indicates that the user has the pre-set property. The representation may be a feature set extracted from sensor data sensed by one or more sensors of the wearable device.

In some instances, the representation (e.g. the extracted feature set) may indicate that the user has the pre-set property, but the recognition algorithm may be unable to correctly identity that the user has the pre-set property from the extracted feature set. For example, the recognition algorithm, may comprise a machine-learned model which was trained on training data obtained from the user under a certain physiological condition or from a different user to the user undergoing the recognition procedure. Advantageously, obtaining the verification information from the user and using the verification information to determine whether to update the recognition algorithm provides a mechanism by which recognition algorithms can be improved over time to improve their recognition accuracy.

Updating the recognition algorithm may comprise indicating to the recognition algorithm that the representation (e.g. the extracted feature set) indicates that the user has the pre-set property. The indicating may comprise adding the extracted feature set to a list of predetermined feature sets associated with the pre-set property. The indicating may comprise replacing the predetermined feature set with the extracted feature set such that in subsequent iterations of the recognition algorithm, the recognition algorithm uses the extracted feature set. The indicating may comprise generating an updated feature set using a combination of the extracted feature set and the predetermined feature set. The recognition algorithm may further comprise determining if the confidence level is greater than or equal to the predetermined threshold, and wherein updating the recognition algorithm may further comprise modifying the predetermined threshold. The recognition algorithm may input the extracted feature set to a machine-learned model which outputs the confidence level, wherein the machine-learned model is trained using training data comprising the predetermined feature set. Updating the recognition algorithm may comprise training the machine-learned model using training data comprises the extracted feature set. Training the machine-learned model may comprise re-training the machine learning model. Training the machine-learned model may comprise updating the machine learning model.

The feature set may be extracted from biometric sensor data sensed by one or more sensors of a wearable device. The recognition algorithm may be a biometric recognition algorithm which uses the extracted feature set and a predetermined feature set representing an authorised user that is authorised to use the wearable device, and generates a confidence level indicating the likelihood that the user wearing the wearable device is the authorised user.

The verification information may be authentication information. The method may further comprise identifying, from the authentication information, whether the user is authorised to use the wearable device. If the user is identified as being authorised to use the wearable device from the authentication information, the method may comprise authenticating the identity of the user wearing the wearable device.

The recognition algorithm may further comprise determining if the confidence level is greater than or equal to the predetermined threshold, and wherein steps (c) to (e) are performed if the generated confidence level is less than the predetermined threshold.

The verification information may be obtained from a separate device to the wearable device. The separate device may be a user electronic device.

The second source of authentication information may be derived from one or more of a passcode, password, fingerprint ID, face ID, gesture, or user input received via the wearable device.

Obtaining the feature set may comprise receiving the feature set from the wearable device. Obtaining the feature set may comprise extracting the feature set from biometric data sensed by the wearable device.

Step (c) may comprise prompting the user to provide the verification information.

According to a sixth aspect of the disclosure, there is provided a computer program. The computer program comprises instructions recorded thereon which, when executed by a computer, cause the computer to perform the method of the first or fifth aspect of the disclosure.

According to a seventh aspect of the disclosure, there is provided a computer-readable medium having instructions recorded thereon which, when executed by a computer, cause the computer to perform the method of the first or fifth aspect of the disclosure.

According to an eighth aspect of the disclosure, there is provided a computer apparatus. The computer apparatus comprises a first obtaining module arranged to obtain representation of sensor data sensed by one or more sensors of a wearable device. The computer apparatus comprises a recognition module arranged to perform a recognition procedure to recognise whether the user wearing the wearable device has a pre-set property, the recognition procedure comprises inputting the representation to a recognition algorithm which uses the representation and a representation determined to be associated with the pre-set property to generate a confidence level indicating the likelihood of the user having the pre-set property. The computer apparatus comprises a second obtaining module arranged to: obtain verification information from the user wearing the wearable device to verify that the user has the pre-set property; and if the verification information verifies that the user has the pre-set property, update the recognition algorithm to reflect that the representation indicates that the user has the pre-set property. The representation may be a feature set extracted from sensor data sensed by one or more sensors of the wearable device.

According to a ninth aspect of the disclosure, there is provided a system. The system comprises a wearable device. The system comprises a computer apparatus of the eighth aspect of the disclosure. The wearable device is arranged to transmit a first source of authentication information to the computer apparatus. The first source of authentication information may comprise a feature set extracted from biometric data sensed by one or more sensors of the wearable device.

According to a tenth aspect of the present disclosure, there is provided a data packet comprising an identifier identifying a wearable device, a first source of authentication information for a user wearing the wearable device, and a second source of authentication information for the user. There may also be provided a computer-readable storage medium storing the data packet of the tenth aspect of the disclosure.

According to an eleventh aspect of the present disclosure, there is provided an electronics module for a wearable device. The electronics module comprises a signal acquisition module arranged to obtain sensor data sensed by one or more sensors of a wearable device, wherein the sensor data is arranged to be used with a recognition algorithm to determine whether the user has a pre-set property. The electronics module comprises a requesting module arranged to prompt the user to provide verification information to verify that the user has the pre-set property. The electronics module comprises an obtaining module arranged to obtain the verification information from the user.

The obtaining module may be an audio input unit arranged to receive verification information in the form of an audio signal. The obtaining module may be a touch sensitive input unit arranged to receive verification information in the form of a touch input. The obtaining module may be a gesture sensor arranged to receive verification information in the form of a sensed gesture.

### BRIEF DESCRIPTION OF THE DRAWINGS

Examples of the present disclosure will now be described with reference to the accompanying drawings, in which:

FIG. 1 shows a schematic view of a system according to aspects of the present disclosure;

FIG. 2 shows a schematic view of a wearable device according to aspects of the present disclosure;

FIG. 3 shows a schematic view of a server according to aspects of the present disclosure;

FIG. 4 shows a schematic view of a user electronic device according to aspects of the present disclosure;

FIG. 5 shows a schematic view of a user interface according to aspects of the present disclosure;

FIG. 6 shows a schematic view of a data packet according to aspects of the present disclosure;

FIG. 7 shows a flow diagram for an example method according to aspects of the present disclosure; and

FIG. 8 shows a flow diagram for an example method according to aspects of the present disclosure.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise.

Referring to FIG. 1, there is shown an example system 10 according to aspects of the present disclosure. The system 10 comprises a wearable device 100 represented as a garment 100 worn by a user. The system 10 comprises a server 200. The wearable device 100 communicates with a server 200 over a cellular network represented by base station 12. The system 10 comprises a user electronic device 300. The wearable device 100 communicates with the user electronic device 300 over a near field or local area communication protocol. The user electronic device 300 communicates with the server 200 over a wireless or wired communication protocol. The wearable device 100 is not required to communicate with the server 200 over the cellular network 12 and may instead communicate with the server 200 via the user electronic device 300. The wearable device 100 comprises sensors that measure signals and transmits the same to the server 200 and/or the user electronic device 300. Generally, the sensors comprise biosensors which are arranged to measure biosignals of the user.

The server 200 receives data sensed by the wearable device 100. The server 200 may analyse the received data. This may involve analysing the received data to determine whether the user has a pre-set property. For example, the server 200 may analyse the data to determine whether the user is fatigued, performing a certain activity like running or walking, dehydrated, or at risk of a medical emergency such as a heart attack. The sever 200 may analyse the data to identify the user. This may involve using biometric data sensed by the wearable device 100 and predetermined biometric data associated with an authorised user to determine whether the user wearing the wearable device 100 is the same as the authorised user. In example implementations, the server 200 uses machine-learned models trained on training data to recognise the pre-set property such as whether the user is the authorised user.

It is an object of the present disclosure to determine whether a user wearing the wearable device 100 is authorised to use the wearable device 100. One reason for this is to establish whether the data received by the user from the wearable device 100 relates to the authorised user. If so, then the server 200 may store the data in a datastore associated with the authorised user, and/or analyse the input data to provide insights about the authorised user. If not, then the server 200 is able to perform an appropriate action to prevent data for an unauthorised user being mixed with the data for the authorised user in the data store, and/or prevent the data for an unauthorised user being used to provide (potentially incorrect) insights in relation to the authorised user.

According to aspects of the present disclosure, a user performs an initial registration procedure so as to indicate to the server 200 that the user is an authorised user of the wearable device 100. This may be performed when the user first purchases the wearable device 100, for example. In general terms, the wearable device 100 establishes a local communication session with user electronic device 300. This can be performed by the user pairing the wearable device 100 to the user electronic device 300. The wearable device 100 transmits an identifier for the wearable device 100 and first authentication information for the wearable device 100 to the user electronic device 300. The user electronic device 300 then prompts the user to provide a second source of authentication information. The user electronic device 300 transmits the identifier for the wearable device 100, the first source of authentication information, and the second source of authentication information to the server 200. The server 200 then updates a database to associate the first source of authentication information with the identifier for the wearable device 100. Optionally, the server 200 also associates the second source of authentication information with the first source of authentication information and the identifier for the wearable device 100.

After the initial registration procedure, a user may wear the wearable device 100. The wearable device 100 may transmit data to the server 200 directly or indirectly via the user electronic device 300. The server 200 may analyse the received data to determine whether the user is authorised to use the wearable device 100. In particular, the wearable device 100 senses biometric signals from the wearer and transmits data derived from the biometric signals to the server 200 over the wireless network 12. The server 200 obtains from the data a first source of authentication information for the user wearing the wearable device 100. The first source of authentication information comprises a feature set extracted from the biometric signals sensed by the wearable device 100. The server 200 inputs the extracted feature set into a recognition algorithm which compares the extracted feature set to a predetermined feature set representing a user that is authorised to use the wearable device 100. The intention is to determine whether the user wearing the wearable device 100 corresponds to the user that is authorised to use the wearable device 100. The recognition algorithm generates a confidence level representing the likelihood of the user being the authorised user. The recognition algorithm compares the confidence level to a predetermined threshold. The confidence level is a value that represents how similar the data received from the wearable device 100 is to predetermined data for an authorised user.

In some examples, if the confidence level is less than a predetermined threshold, the server 200 transmits a request to the user electronic device 300 for a second source of authentication information. The user electronic device 300 prompts the user to provide the second source of authentication information. This may be a fingerprint read by a fingerprint reader of the user electronic device 300, for example. The user electronic device 300 transmits the second source of authentication information to the server 200. The server 200 authenticates the identity of the user wearing the wearable device 100 as corresponding to the authorised user. In some examples, the second source of authentication information is requested regardless of whether the confidence level is less than or greater than the predetermined threshold.

In examples of the present disclosure, if the user is authenticated, the server 200 enables data transmitted by the wearable device 100 to the server 200 to be associated with the user, analysed to provide insights in relation to the user, stored in a datastore associated with the authorised user, and/or used to train one or more machine-learned models associated with the user.

In examples of the present disclosure, if the user is authenticated, the server 200 updates the recognition algorithm to reflect that the extracted feature set belongs to the user that is authorised to use the wearable device 100.

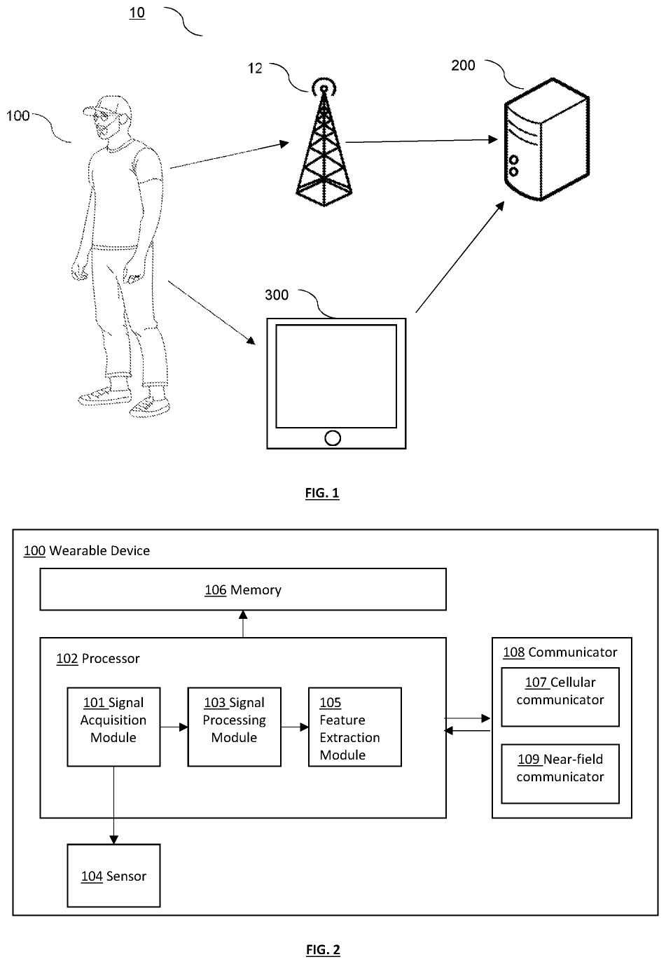

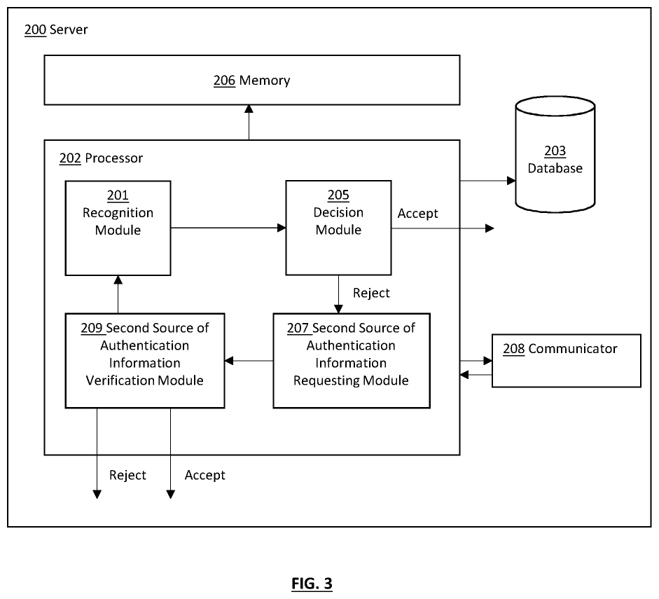

Referring to FIG. 2, there is shown a schematic view of an example wearable device 100 according to aspects of the present disclosure. The wearable device 100 comprises a signal acquisition module 101, a signal processing module 103, and a feature extraction module 105. The modules 101, 103, 105 are functional components of a processor 102 of the wearable device 100. The processor 102 accesses instructions and stores data in a memory 106 of the wearable device 100.

The wearable device 100 comprises a sensor 104 for measuring biometric signals of the user wearing the device 100. “Biometric signals” may refer to any signal obtained from a living being that contain identifying information for the user and which may alone, or in combination with other data, be used to identify the wearer of the wearable device 100. The sensor 104 may measure a biometric property of the wearer that uniquely identifies the wearer. This may be for example, a biometric signal that relates to the user's heart rate variability.

The sensor 104 may comprise an optical sensor. An optical sensor may measure the amount of ultraviolet, visible, and/or infrared light in the environment. The optical sensor may comprise a photoplethysmographic (PPG) sensor. PPG sensors measure blood volume changes within the microvascular bed of the wearer's tissue. PPG sensors use a light source to illuminate the tissue. Photodetectors within the PPG sensor measure the variations in the intensity of absorbed or reflected light when blood perfusion varies. PPG signals measured by a PPG sensor can be used to uniquely identify a wearer because unique characteristics of the wearer's vascular system lead to unique features being present in the PPG signal. The second derivative of PPG signals (SDPPG) may also be used to uniquely identify a person as SDPPG signals vary from person to person. The optical sensor may comprise an image sensor. The image sensor may be arranged to image a face of a user wearing the wearable device 100 if facial features are used as (part of) the biometric identity of the user. The image sensor may be arranged to image other body features or the gait of a user wearing the wearable device 100 so as to uniquely identify the user wearing the wearable device 100. The image sensor may be arranged to image a fingerprint or palmprint of the user wearing the wearable device 100. The image sensor may be a camera. In the context of fingerprint readers, the present disclosure does not require to use optical based technology and other forms of fingerprint readers such as those using capacitive or ultrasonic technology are within the scope of the present disclosure.

The sensor 104 may comprise a force sensor. A force sensor refers to a sensor that measure the force that affects the sensor. The force may be due to movement in the case of an accelerometer such as a 3-axis accelerometer, the Coriolis force in the case of a gyroscope, the Earth's magnetic field in the case of a magnetometer, or air pressure in the case of a barometer. The force sensor may comprise an accelerometer such as a 3-axis accelerometer. An accelerometer can measure forces produced by muscular induced movement of the wearer. This muscular induced movement depends on the user physiology and behaviour (such as their gait) and can be used to uniquely identify the wearer. The sensor 104 may comprise a magnetometer which measures the strength of the magnetic field and thus can be used to derive the strength and direction of the Earth's magnetic field. The magnetometer may measure the strength of the magnetic field along three axes. Magnetometer data can be used to drive the heading of the user wearing the wearable device 100 which can provide behavioural biometric signals for use in identifying the user wearing the wearable device 100. The sensor 104 may comprise a gyroscope. Gyroscopes are able to measure the attitude and rotation of different body parts of the user depending on their positioning in the wearable device 100 and the location of the wearable device 100 on the body. This information provides behavioural biometric signals which can be used to uniquely identify the user.

The sensor 104 may comprise an electrical sensor. An electrical sensor may measure the electrical activity of a part of the body or how a current changes which it is applied to the body. An electrical sensor may perform biopotential measurements. An example biopotential sensor is an electrocardiaogram, ECG, sensor that measures the electrical activity of the heart. A user's heartbeat may be analysed using patterns gathered by the ECG sensor, which records a heart's electric potential changes in time. A longer recording of heartbeat activity is called an electrocardiogram (ECG) and is recorded using one or more pairs of electrodes. The change of electrical potential is measured between the points of contact of the electrodes. This change is strongly correlated with heart and muscle activity of the subject as the heartbeat activity of the human body is stimulated through electrical impulses. An electrical sensor may perform bioimpedance measurements. That is, the electrical sensor may comprise a bioimpedance sensor. Bioimpedance measurements may be obtained by performing different impedance measurements between different points on user's body at different frequencies. An example bioimpedance sensor is a galvanic skin response sensor that measures the skin conductance. The skin conductance varies depending on the amount of moisture (induced by sweat) in the skin. Sweating is controlled by the sympathetic part of the nervous system, so it cannot be directly controlled by the subject. The skin conductance can be used to determine body response against physical activity, stress or pain. The body response against these stimuli differ from person to person and so can be used to uniquely identify the wearer of the wearable device 100.

The sensor 104 may comprise a temperature sensor such as a skin temperature sensor. A skin temperature sensor may comprise a thermopile arranged to capture infrared energy and transform it into an electrical signal that represents the temperature. The skin temperature may be unique to the user, and in particular may vary in a unique or predictable way in response to physical activity, stress or pain.

The sensor 104 may comprise an acoustic sensor. The acoustic sensor may comprise a microphone. The acoustic sensor may be arranged to measure the user's voice. The user's voice is defined by the physiological characteristics of their respiratory system and can be used to uniquely identify the user. In addition, other properties such as the vocabulary, style, syntax, and other features of speech also identify the user and can be determined from the captured audio signal. The acoustic sensor may be arranged to measure other (typically low power) sounds emitted from the user, such as the user's heart. Therefore, the acoustic sensor can measure heartbeat sounds which can be used to define the heart rate variability or other uniquely identifying property of the user wearing the wearable device 100.

Generally, ECG sensors are preferred and the disclosure of the present disclosure is particularly suited to accommodate for variation in ECG signals over time. However, the present disclosure is not limited to the particular sensors 104 described above. Other examples sensors such as radar sensors, biochemical sensors and location sensor can be used in uniquely identifying the user. Moreover, a combination of different types of sensors may be used to uniquely identify the user. That is, the signal acquisition module 101 may receive signals from a plurality of sensors 104. The signal processing module 103 may pre-process the signals, and the feature extraction module 105 extracts the most significant features from the plurality of sensors. In other examples, a plurality of feature sets may be extracted each associated with sensor data from a different one of the plurality of sensors. The wearable device 100 may transmit the plurality of feature sets to the server 200 which may then input them to the recognition algorithm.

The wearable device 100 may comprise other sensors for measuring other signals such as other biosignals of the wearer. “Biosignals” may refer to any signal obtained from a living being that can be measured and monitored.

The signal acquisition module 101 is operable to acquire, typically raw, biometric signals from the sensor 104.

The signal processing unit 103 pre-processes the biometric signals. The biometric signals obtained from the one or more sensors are typically affected by noise and changes in physical conditions. This can be a particular problem for wearable devices due to factors such as reduced size, battery life, hardware considerations, and poor skin contact. The configuration of the sensors, differences in timing measurements, the technical limitations of the sensors can introduce noise and errors into the obtained biosignals. The signal processing unit 103 pre-processes the signals so as to reduce nose, errors, optionally normalize the data, and generally prepare the raw signal for the feature extraction process. The use of specific pre-processing techniques greatly depends on the domain and the scenario. Example techniques include normalization, smoothing, interpolation, or segmentation or a combination thereof.

The feature extraction module 104 extracts a feature set from the processed biometric signals. This process may be considered as an extraction and selection process whereby a plurality of features are extracted from the processed biometric signals and the most significant of these features are then selected to form the extracted feature set. Feature extraction as performed by the feature extraction module 104 is aimed at reducing the noise, redundancy, and dimensionality of the processed biometric signal so that only significant information remains. This means that the recognition algorithm only has to consider the most significant information from the biometric signals. With feature extraction, a signal can be compared to others in the time, frequency, and other domains defined by the extracted features.

The feature extraction module 104 may use a domain-driven approach to extract features from the processed biometric signals. A domain-driven approach extracts features from the processed biometric signals using knowledge from the problem domain. Domain knowledge-based features are able to summarise the relevant information in a processed biometric signal into a reduced set of features. Additionally or separately, the feature extraction module 104 may use an automatic driven approach to extract features from the processed biometric signals. The automatic-driven approach may use statistics and other techniques to automatically extract features. Statistical features such as the mean, standard deviation, maxima and minima can be extracted as features from processed biometric signals. These features can be extracted from all biometric signals independently of the domain of the biometric signal. Of course, other forms of feature extraction process as known by the skilled person may be performed as appropriate.

Not all of the features extracted by the feature extraction module 104 may be relevant or useful for the recognition problem that is solved by the recognition algorithm. Some of the extracted features may even be redundant or misleading. Further, the number of extracted features generally determines the computational cost of the recognition process. To this end, once the features have been extracted by the feature extraction module 104, the feature extraction module may perform a feature selection process to reduce the size of the feature set used in the subsequent recognition operation. Feature selection approaches generally iterate through the extracted features to obtain the best set of extracted features to represent the biometric signal.

The feature extraction module 104 may use a principal component analysis (PCA) based procedure to reduce the dimensionality of the extracted feature set. PCA is a well-known unsupervised machine learning approach. In general terms, the goal of PCA is to reduce the dimensionality of a set of d samples (the features extracted by the feature extraction module 104) to a smaller set of k samples that is representative of the original d samples. Here, d and k are numbers where k is less than d. To do this, the feature extraction module 104 generally computes a covariance matrix from the set of d samples and from the covariance matrix determines a matrix of eigenvectors and corresponding eigenvalues. The more dominant features of the samples are contained in the eigenvectors with the highest eigenvalues. The eigenvectors are sorted in order of decreasing eigenvalue and the k eigenvectors associated with the k largest eigenvalues are selected. A projection matrix W is then generated which contains the k selected eigenvectors. The projection matrix is of size d×k. The feature extraction module 104 then transforms the original d samples via the projection matrix W so as to obtain a new dataset of size k.

The feature extraction module 104 may use a linear discriminant analysis (LDA) based procedure to reduce the dimensionality of the extracted feature set. LDA is another well-known unsupervised machine learning approach. The object of LDA is to generate a projection that maximises the separation between samples from different classes. In LDA, the eigenvectors and eigenvalues are calculated from a combination of the within-class scatter matrix and between-class scatter matrix. The transformation of the samples into the vector space defined by the selected subset of eigen vectors in much the same way as PCA.

The feature extraction module 104 is not limited to the use of PDA or LDA to reduce the dimensionality of the extracted feature set. Other selection techniques as known by the skilled person such as mutual information, correlation and fast correlation may be used as appropriate.

The wearable device 100 further comprises a communicator 106. The processor 102 is operable to control the communicator 108 to communicate with external devices. The communicator 108 is able to wirelessly communicate with the server 200 and the user electronic device 300. The communicator 108 comprises a first wireless communicator 107 for communicating with external devices, such as server 200, over a wireless network such as a cellular network. The first wireless communicator 107 is a mobile/cellular communicator 107 operable to communicate the data wirelessly via one or more base stations. The communicator 107 provides wireless communication capabilities for the wearable device 100 and enables the wearable device 100 to communicate via one or more wireless communication protocols such as used for communication on: a wireless wide area network (WWAN), a wireless metroarea network (WMAN), a wireless local area network (WLAN), a wireless personal area network (WPAN), a near field communication (NFC), and a cellular communication network. The cellular communication network may be a fourth generation (4G) LTE, LTE Advanced (LTE-A), fifth generation (5G), sixth generation (6G), and/or any other present or future developed cellular wireless network. The communicator 108 comprises a short-range local communicator 109 for communicating with external devices, such as user electronic device 300 over short-range communication networks such as WLAN, WPAN, near-field communication, or Bluetooth® networks.

The wearable device 100 may be any form of electronic device which may be worn by a user such as a smart watch, necklace, bracelet, or glasses. The wearable device 100 may be a textile article. The wearable device 100 may be a garment. The garment may refer to an item of clothing or apparel. The garment may be a top. The top may be a shirt, t-shirt, blouse, sweater, jacket/coat, or vest. The garment may be a dress, brassiere, shorts, pants, arm or leg sleeve, vest, jacket/coat, glove, armband, underwear, headband, hat/cap, collar, wristband, stocking, sock, or shoe, athletic clothing, swimwear, wetsuit or drysuit The garment may be constructed from a woven or a non-woven material. The garment may be constructed from natural fibres, synthetic fibres, or a natural fibre blended with one or more other materials which can be natural or synthetic. The yarn may be cotton. The cotton may be blended with polyester and/or viscose and/or polyamide according to the particular application. Silk may also be used as the natural fibre. Cellulose, wool, hemp and jute are also natural fibres that may be used in the garment. Polyester, polycotton, nylon and viscose are synthetic fibres that may be used in the garment.

Referring to FIG. 3, there is shown a schematic view of an example server 200 according to aspects of the present disclosure. The server 200 comprises a recognition module 201, a decision module 205, a second source of authentication information requesting module 207 (requesting module 207), and a second source of authentication information verification module 209 (verification module 209). The modules 201, 205, 207, 209 are functional components of a processor 202 of the server 200. The processor 202 accesses instructions and stores data in a memory 206 of the server 200. The server 200 further comprises a database 203. The server 200 further comprises a communicator 208. The processor 202 is operable to control the communicator 208 to communicate with external devices. The server 200 is not required to be a single computing apparatus. That is, a plurality of computing apparatuses cooperating together may perform the functionality of the server 200. That is, a distributed computing apparatus may perform the functionality of the server 200. The server 200 may be a cloud server 200.

In example implementation, the server 200 performs a registration procedure in which it receives an identifier, first authentication information, and second authentication information from the user electronic device 300 and registers the user identified by the first and second authentication information with the identifier. This may involve storing the first authentication information or information derived from the first authentication information in the database 203.

The database 203 may store machine learned models based on feature sets for authorised users of wearable devices 100 (FIG. 1) and/or may store the features sets for the authorised users. The database 203 may link identifiers for wearable devices 100 to first authentication information and optionally second authentication information of authorised users for particular wearable devices 100. An example table arrangement which may be used by the database 203 is shown in the below Table 1.

TABLE 1

| Identifier for | First authentication | Second authentication |
|---|---|---|
| wearable device | Information | Information |
| A1 | B1 | C1 |
| | B2 | C2 |
| | B3 | C3 |
| A2 | B1 | C1 |
| | B4 | C4 |
| A3 | B5 | C5 |
| A4 | B6 | C6 |

Table 1 shows a tabular representation of how data may be stored in the database 203. In the database 203, four identifiers A1, A2, A3, A4 are stored which each identify a different wearable device. The first wearable device identified by identifier A1 has three authorised users. The database 203 stores first authentication information and second authentication information for these authorised users (B1, C1), (B2, C2), (B3, C3). The second wearable device identified by identifier A2 has two authorised users. The database 203 stores first authentication information and second authentication information for these authorised users (B1, C1), (B4, C4). The third wearable device identified by identifier A3 has one authorised user. The database 203 stores first authentication information (B5) and second authentication information (C5) for this authorised user. The fourth wearable device identified by identifier A4 has one authorised user. The database 203 stores first authentication information (B6) and second authentication information (C6) for this authorised user. It will be appreciated that the second authentication information is not required to be stored in all aspects of the present disclosure. That is, the second authentication information may just be an “OK” input via the user electronic device 300 when prompted to indicate that they are wearing the wearable device 100. This means that the second authentication information transmitted by the user electronic device 300 is effectively a verification signal that does not need to be stored in the database 203.

In example implementations, the server 200 performs an authentication procedure in which it authenticates a user wearing the wearable device 100 as being authorised. In these implementations, the server 200 receives the first source of authentication information from the wearable device 100. The recognition module 201 is arranged to obtain the first source of authentication information from the wearable device 100 and use this information to confirm the identity for the user wearing the wearable device 100. The first source of authentication information comprises the extracted feature set. The recognition module 201 runs a recognition algorithm which uses the extracted feature set and predetermined feature set representing an authorised user that is authorised to use the wearable device 100 and generates a confidence level indicating the likelihood that the user wearing the wearable device 100 is the authorised user. The recognition module 201 may operate in a verification mode (to confirm whether or not the user is authorised) or an identification mode (to identify a particular user).

The recognition module 201 may use either or a combination of similarity and machine learning techniques. The recognition module 201 generates a confidence level, which may be a numerical value, that indicates the likelihood that the user wearing the wearable device 100 is the authorised user. The recognition module 201 compares the confidence level to a predetermined threshold.

The similarity measure may involve the use of a distance function which will be understood as referring to a function used to calculate a distance between the extracted feature set and a predetermined feature set. Example distance functions include the Euclidean distance, Manhattan distance and the Mahalabonis distance. Other forms of distance function are within the scope of the present disclosure. The similarity measure may involve the user of a dynamic time warping (DTW) function which will be understood as referring to a function that measures the distance between two time series. A fast DTW approach may also be used, which will be understood as referred to a DTW approach that introduces one or more constraints into the algorithm to reduce the computational cost compared to DTW. Other examples of similarity measure include correlation, which measures the similarity between feature sets as a function of the lag between them, and coherence, which determines the similarity between feature sets by comparing the frequencies. To determine the coherence a feature set in the time domain may be converted into the frequency domain using a frequency transform operation such as a Fourier transform or a Discrete Cosine Transform. It will be appreciated that one or a combination of similarity measures may be selected as appropriate by the skilled person based on factors such as the computational resources available, computational time, and type of feature set.

The recognition module 201 may use one or more machine learning algorithms to verify or identify the user wearing the wearable device 100. This can involve comparing the received feature set to one or more predetermined feature sets associated with a single authorised user (a one-class classification problem) or can involve comparing the received feature set to feature sets associated with a plurality of authorised users so as to identify which of the plurality of authorised users is the closest match to the user wearing the wearable device 100 (a multi-class classification problem). The machine learning algorithm outputs a similarity measure.

In general terms, machine learning algorithms build a machine-learned model based on training data. In this case, the training data relates to feature sets for pre-identified users. In the training phase, the training data is used to train the machine-learned model to create, as an output, a machine-learned model representative of the received training data.

One example machine-learned model is an artificial neural network (ANN). An ANN is a model based on a collection of connected nodes. Each connection can transmit an output from one node to another. A node that receives an output from another node can process it and then transmit outputs to additional nodes connected to it. Each node in the ANN produces its output by applying a combination of functions (propagation, activation and transfer) to the node inputs. During the training phase, the ANN is presented with samples from the training data and the weights of the propagation function are adjusted depending on the output of the nodes and label of each training register. The nodes in the output layer generate the output value of the neural network.

Another example machine-learned model is a Bayesian network. A Bayesian network represents a probabilistic model of a problem as a directed acyclic graph (DAG). Directed edges in the Bayesian network that connect two nodes of the DAG are associated with a probability which represents the conditional probability that the source of the edge will happen given that the destination node of the edge happens. The probability of an input feature set belonging to a (specific) authorised user is calculated chaining the conditional probabilities of each of the nodes connected to the subject node. Naive Bayes is a special case of Bayesian network where the node representing the authorised user can only have children and features are independent. Naive Bayes builds a probabilistic model of the authorised user's features. Naive Bayes operates on the principle that future observations of a feature set belonging to an authorised user will follow the same probabilistic distribution of feature sets that were given for training for the same authorised user, and that the value of a feature is independent of the value taken by other features.

Other example machine-learned models/algorithms that may be used within the scope of the present disclosure include K-nearest neighbour techniques, support vector machine techniques, Gaussian mixture models, hidden Markov models, decision trees, and genetic algorithms. Of course, other machine learning techniques as known to the skilled person may be used in the context of the present disclosure.

The recognition module 201 generates a confidence level that indicates the likelihood that the user wearing the wearable device 100 is the authorised user. The recognition module 201 then compares the confidence level to a predetermined threshold and determines whether the confidence level is less than or greater than the predetermined threshold. It will be appreciated that the value of the threshold may be selected as appropriate by the skilled person in the art based on factors such as the intended level of security of the system. For example, in a consumer grade system an excessive number of false negatives may be undesirable as it may limit a user's interaction with the system, and so a lower threshold may be set. Meanwhile, in a high-security system, such as for use in military applications, an excessive number of false positives may be undesirable as they may compromise the integrity of the security system, and so a higher threshold may be set. The result of the determination is provided to the decision module 205. If the confidence level is greater than the predetermined threshold, the decision module 205 decides that the user wearing the wearable device 100 is authorised and then enables an action to be performed. If the confidence level is less than the predetermined threshold, then the server 200 enters a second authentication procedure. In the second authentication procedure, the second source of authentication information requesting module 207 requests a second source of authentication information for verifying the identity of the user.

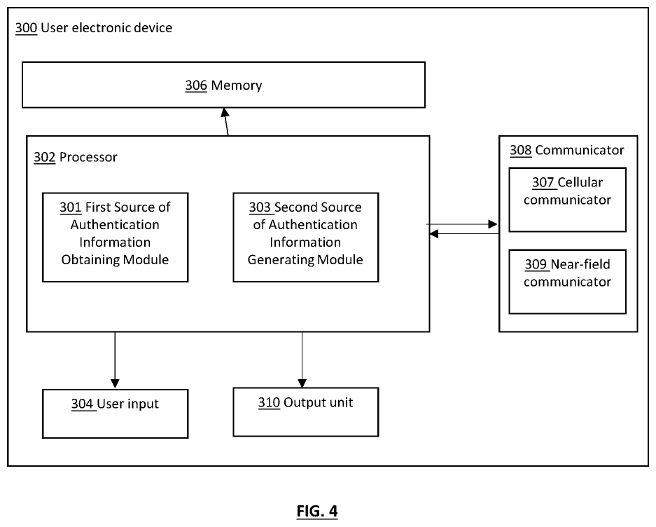

Referring to FIG. 4, there is shown a schematic view of an example electronic device and in particular a user electronic device 300 according to aspects of the present disclosure. The user electronic device 300 comprises a first source of authentication information obtaining module 301 and a second source of authentication information generating module 303. The modules 301, 303 are functional units of a processor 302. The processor 302 accesses instructions and stores data in a memory 306 of the user electronic device 300. The user electronic device 300 further comprises a user input 304. The user input 304 may be any or a combination of a tactile input, presence sensitive input, camera, microphone or gesture sensor such as an accelerometer or inertial measurement unit. Other forms of user input 304 are within the scope of the present disclosure. The user electronic device 300 further comprises an output unit 310

The user electronic device 300 further comprises communicator 308. The communicator 308 comprises a cellular communicator 307 for communicating with external devices, such as server 200, over a cellular network. The communicator 308 comprises a near-field communicator 309 for communicating with external devices, such as user electronic device 300 over a near-field communication network.

The electronic device 300 is not limited to a user electronic device/mobile phone and instead any electronic device 300 capable of communicating with a server 200 and a wearable device 100 over a wired or wireless communication network may function as an electronic device 200 in accordance with the present invention. The electronic device 200 may be a wireless device or a wired device. The wireless/wired device may be a mobile phone, tablet computer, gaming system, MP3 player, point-of-sale device, or wearable device such as a smart watch. A wireless device is intended to encompass any compatible mobile technology computing device that connects to a wireless communication network, such as mobile phones, mobile equipment, mobile stations, user equipment, cellular phones, smartphones, handsets or the like, wireless dongles or other mobile computing devices. The wireless communication network is intended to encompass any type of wireless such as mobile/cellular networks used to provide mobile phone services.

In example implementations, the user electronic device 300 may not be required or may to perform all of the actions described above. That is, the wearable device 100 may communicate directly with the server without requiring the user electronic device 300 to act as an intermediary. Moreover, the wearable device 100 may obtain the second source of authentication information from the user. The wearable device 100 may comprise an output unit to prompt the user to provide the second source of authentication information and an input unit to obtain the second source of authentication information. The output unit may be a speaker, display, or haptic feedback unit for example. The input unit may sense a touch input, gesture input, voice command input or similar from the user.

Moreover, in some implementations, the wearable device 100 performs all of the method. That is, the server 200 and user electronic device 300 may not be required in some aspects of the present disclosure. The wearable device 100 may sense the biometric data, perform the recognition process, and prompt and obtain the second source of authentication information.

Example operations according to aspects of the present disclosure will now be described with reference to FIGS. 1 to 6.

Registration Stage

According to aspects of the present disclosure, a user may initially obtain a wearable device 100 that the user is not yet an authorised user of. To register the user as an authorised user of the wearable device 100 a registration process may be performed. In an example registration process, the user first logs in to their user account via user electronic device 300. The user electronic device 300 transmits the login information to server 200. If the login information corresponds to an existing user account maintained by the server 200 then the server 200 enables the user to access their user account. If the user does not already have a user account with the server 200, then the user may be prompted to create a new user account with the server 200.

Once the user has logged into their account, a user interface for the user account is displayed on the user electronic device 300. FIG. 5 shows an example user interface. The user interface comprises selectable visual elements 311, 313, 315, 317 each associated with a different wearable device 100 of the user that is registered with the user account. Selection of a visual element 311, 313, 315, 317 will cause the user interface to display information associated with the selected wearable device 100. The user interface further comprises a selectable visual element 319 entitled “Add clothes”. Selection of the visual element 319 triggers a process by which a wearable device 100 may be registered to the user account. In particular, in response to the selection of the visual element 319 the user is prompted to pair the user electronic device 300 to the wearable device 100 over a nearfield communication protocol.

The sensor 104 of the wearable device 100 senses a biometric signal of the wearer. The biometric signal is acquired by the signal acquisition module 100 and then pre-processed by the signal processing module 103. The feature extraction module 105 extracts a feature set from the processed biometric signal and the extracted feature set is transmitted to the user electronic device 300 via the near-field communicator 109. The near-field communicator 109 also transmits an identifier for the wearable device 100 to the user electronic device 300. The identifier may be stored in the memory 106.

In response to receiving the identifier and the extracted features set, the second source of authentication information generating module 303 triggers the output unit 301 of the user electronic device 300 to generate an output for prompting the user to provide a second source of authentication information. In this example, the second source of authentication information that is requested is a fingerprint read via a fingerprint reader of the user input 304 of the user electronic device 300. The second source of authentication information generating module 303 processes the fingerprint data to extract a feature set from the fingerprint data. The processor 302 controls the cellular communicator 307 to transmit the identifier for the wearable device 100, first authentication information comprising the feature set extracted from biometric data sensed by the wearable device 100, and second authentication information comprises the feature set extracted from the fingerprint data sensed by the user electronic device 300 to the server 200. The server 200 stores the identifier for the wearable device 100, first source of authentication information, and second source of authentication information in the database 203.

Training Stage

Once the server 200 has received first authentication information which has been confirmed by the user as belonging to the user via the second authentication information, the user is able to train a machine-learned model for identifying the user. In this way, future first authentication information received by the server 200 can be input into the machine-learned model to determine whether or not the future first source of authentication information relates to the particular user. In an example operation according to aspects of the present disclosure, the extracted feature set of the first source of authentication information is used as training data for the machine-learned model. The server 200 may use a plurality of extracted feature sets for the user to train the machine-learned model. For example, during the registration phase, the wearable device 100 may perform multiple biometric signal acquisitions and transmit multiple extracted feature sets relating to one or a plurality of sensors for the wearable device 100. The biometric signal acquisitions may be read at different times of day or during different activity levels of the user such as when the user is at rest and when the user is undergoing strenuous exercise. In this way, the machine-learned model may reflect different activity levels of the user and thus be able to perform a successful user recognition in a variety of different situations.

Authorisation Stage

Once the registration procedure is complete, the wearable device 100 is able to transmit data to the server 200 over the wireless e.g. cellular network. That is, data transmissions do not need to be performed via the user electronic device 300. The wearable device 100 may stream data to the server 200 continuously or may intermittently transmit data to the server 200. Upon receipt of data from the server 200, the server 200 performs an authentication procedure on the data to determine whether the user wearing the wearable device 100 is authorised. The server 200 may not perform this authentication procedure every time data is received by the server 200. The server 200 may, for example, perform the authentication procedure once per communication session or may perform the authentication procedure after a predetermined time duration has elapsed since the previous authentication procedure. For example, the server 200 may perform the authentication procedure once a day, once every 6 hours, or once per hour.

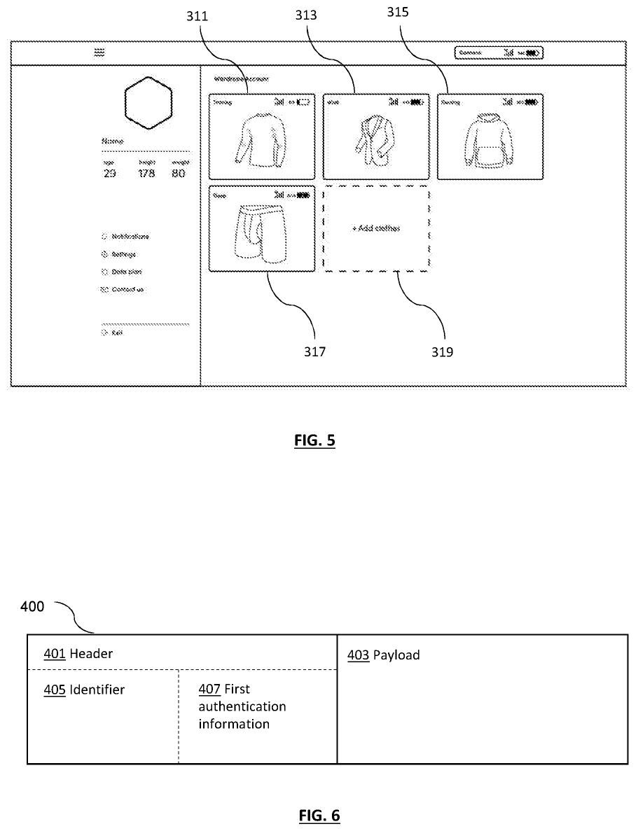

Referring to FIG. 6, there is shown an example data packet 400 transmitted by the wearable device 100 to the server 200. The data packet 400 comprises a header 401 and a payload 403. The header 401 comprises the identifier 405 for the wearable device 100 and the first source of authentication information 407. The first source of authentication information 407 comprises the feature set extracted from the biometric signals sensed by the wearable device 100. The payload 403 comprises other data such as sensor data obtained from sensors of the wearable device 100. The sensor data may comprise raw sensor data or local processing may be performed on the sensor data prior to transmission to the server 200.

The data packet 400 is received by the communicator 208 (FIG. 3) of the server 200 under the control of the processor 202. The recognition module 201 performs an initial verification procedure which involves checking whether the identifier 405 exists in the database 203. If the identifier exists in the database 203, the recognition module 201 runs a recognition algorithm using the first source of authentication information 407 and, in particular, the extracted feature set contained in the first source of authentication information 407 as an input. The recognition algorithm generates a confidence level representing the likelihood that the user wearing the wearable device 100 is the authorised user.

In some examples, the recognition module 201 performs a verification operation which acts to confirm whether the extracted feature set corresponds to an authorised user. In other examples, the recognition module 201 performs an identification operation which acts to identify the particular authorised user that is wearing the wearable device 100. As explained above, the recognition module 201 may use either or a combination of similarity and machine learning techniques. The recognition module 201 generates a confidence level, which may be a numerical value, compares the confidence level to a predetermined threshold and determines whether the confidence level is less than or greater than the predetermined threshold. A decision module 205 decides if the user wearing the wearable device 100 is authorised and then enables an action to be performed. If the confidence level is less than the predetermined threshold, then the server 200 enters a second authentication procedure.

During the second authentication procedure, the decision module 205 indicates to the second source of authentication information requesting module 207 that the user is not authorised. The requesting module 207 generates a request for the user to provides a second source of authentication information. The requesting module 207 transmits the request to the user electronic device 300 associated with the user. The user electronic device 300 may be a device 300 that the user has already linked to their account on the server 200. For example, the user electronic device 300 may be running an application in which the user has logged in to their account on the server 200. In other examples, the user electronic device 300 is in local communication with the wearable device 100, and the server 200 transmits request to wearable device 100 and wearable device 100 forwards on to user electronic device 300.

The user electronic device 300 prompts the user to provide a second source of authentication information. For example, the user electronic device 300 may provide an audio, visual or haptic feedback output via the output unit 310 (FIG. 4) to the user to prompt the user to enter the second source of authentication information. The user then provides the second source of authentication information. This may be a password or passcode provided via a user interface of the user electronic device. The user electronic device 300 may comprise a fingerprint reader and the second source of authentication information may be derived from a fingerprint read by the user electronic device 300. The user electronic device 300 may comprise a camera and the second source of authentication information may be derived from a facial image of the user captured by the camera of the user electronic device 300. The user electronic device 300 may comprise a microphone and the second source of authentication information may be derived from a voice signal uttered by the user and captured by the microphone of the user electronic device 300. The voice signal may be recognised by the user electronic device 300 or the server 200 to identify the user. The voice signal may comprise a password or passcode that is recognised and used to confirm the identity of the user. The user electronic device 300 comprises a second source of authentication information generating module 301 that generates the second source of authentication information and transmits the same to the requesting module 207 of the server 200.

The request module 207 provides the second source of authentication information to the second source of authentication information verification module 209. The verification module 209 verifies, from the second source of authentication information, whether the user is authorised to use the wearable device 100. For example, if the second source of authentication information is a feature set for a fingerprint recorded by the user electronic device 300, then the verification module 209 compares the obtained feature set to a predetermined feature set for an authorised user. If the obtained feature set corresponds to the predetermined feature set, then the verification module 209 decides that the user wearing the wearable device 100 is authorised and then enables an action to be performed. The action could involve allowing the payload 403 (FIG. 5) of the data packet 400 to be processed, analysed to provide insights for the user, and/or stored in a data store associated with the user.

In addition, the verification module 209 may instruct the recognition module 201 to update the recognition algorithm to reflect that the extracted feature set belongs to the user that is authorised to use the wearable device 100. This may only be performed if the confidence level determined by the recognition algorithm is within a certain range of the predetermined threshold. For example, the predetermined threshold may be 90% and extracted feature sets with a confidence level of greater than 80% may be used to update the recognition algorithm. Of course, other percentage values are within the scope of the present disclosure. In some instances, all feature sets verified by the user may be used to update the recognition algorithm.

The recognition module 201 may update the recognition algorithm by indicating to the recognition algorithm that the extracted feature set belongs to the authorised user.

In examples of the present disclosure, the recognition module 201 may indicate to the recognition algorithm that the extracted feature set belongs to the authorised user by adding the extracted feature set to a list of predetermined feature sets associated with the authorised user. The recognition module 201 will use the modified list of predetermined feature sets in future iterations of the recognition algorithm. Rather than adding the extracted feature set to the list of predetermined feature sets, the recognition module 201 may replace an (or the only) predetermined feature set associated with the authorised user with the extracted feature set. Alternatively, the recognition module 201 may update a predetermined feature set using the extracted feature set associated with the authorised user. This could involve taking replacing the predetermined feature set with a new feature set that represents a combination (e.g. an average of) the predetermined feature set and the extracted feature set.

In examples of the present disclosure, the recognition module 201 may indicate to the recognition algorithm that the extracted feature set belongs to the authorised user by updating the predetermined threshold. That is, the predetermined threshold may be lowered to reduce the likelihood of a false negative occurring.

In examples of the present disclosure, the recognition module 201 may indicate to the recognition algorithm that the extracted feature set belongs to the authorised user by updating the machine-learned model used by the recognition algorithm, In particular, the recognition module 201 may update the machine-learned model using the extracted feature set such as by retraining the machine-learned model using the obtained feature set as training data. If the machine-learned model is an artificial neural network (ANN) this may mean that the weights of the ANN of the propagation function are adjusted. Of course, other forms of machine-learned model may be updated in the same or a similar way.

Referring to FIG. 6, there is shown a flow diagram for an example method of authenticating the identity of the user wearing the wearable device.

Step S101 of the method comprises obtaining a first source of authentication information for a user wearing the wearable device. The first source of authentication information comprises a feature set extracted from biometric data sensed by one or more sensors of the wearable device. The feature set may be a feature vector or other simplified representation of the biometric data sensed by the wearable device. That is, the first source of authentication information may comprise only the most significant information from the sensed biometric data. Of course, in other implementations the first source of authentication information is the sensed biometric data, and the subsequent steps of the method may be performed on the sensed biometric data.

Step S102 of the method comprises inputting the extracted feature set into a recognition algorithm which uses the extracted feature set and predetermined feature set representing an authorised user that is authorised to use the wearable device, and generates a confidence level indicating the likelihood that the user wearing the wearable device is the authorised user.

Step S103 of the method comprises obtaining a second source of authentication information from the user of the wearable device.

Step S104 of the method comprises identifying, from the second source of authentication information, whether the user is authorised to use the wearable device.

Step S105 of the method comprises, if the user is identified as being authorised to use the wearable device from the second source of authentication information, authenticating the identity of the user wearing the wearable device as corresponding to the authorised user.

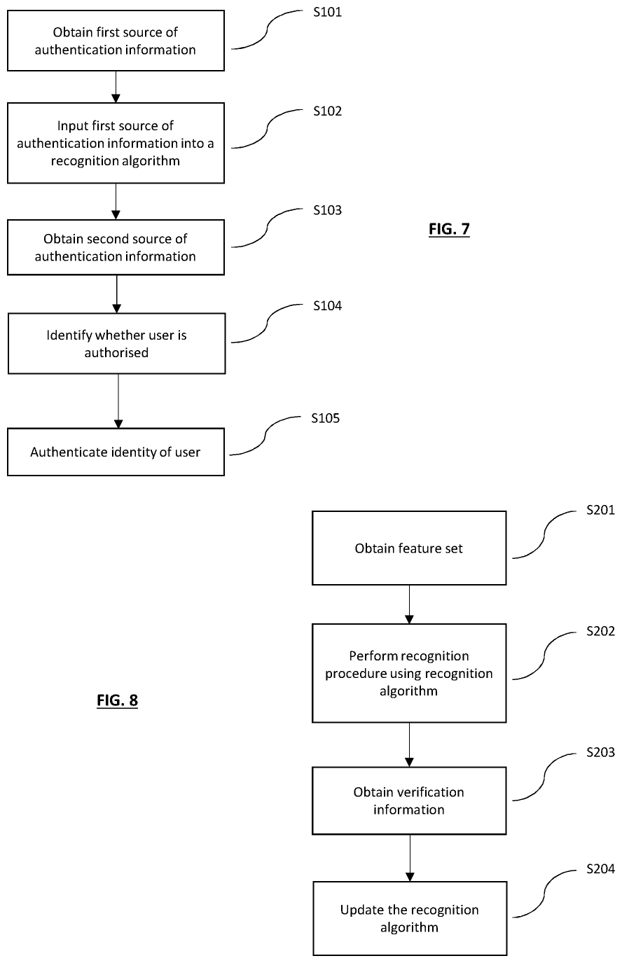

Referring to FIG. 7, there is shown a flow diagram for an example method of updating a recognition algorithm.

Step S201 of the method comprises obtaining a feature set extracted from sensor data sensed by one or more sensors of a wearable device. The feature set may be a feature vector or other simplified representation of the sensor data sensed by the wearable device. That is, the feature set may comprise only the most significant information from the sensed data. Of course, in other implementations the recognition algorithm uses the data sensed by the sensors of the wearable device rather than an extracted feature set.

Step S202 of the method comprises performing a recognition procedure to recognise whether the user wearing the wearable device has a pre-set property. The recognition procedure comprises inputting the extracted feature set to a recognition algorithm which uses the extracted feature set and a feature set determined to be associated with the pre-set property to generate a confidence level indicating the likelihood of the user having the pre-set property.

Step S203 of the method comprises obtaining verification information from the user wearing the wearable device to verify that the user has the pre-set property.

Step S204 of the method comprises, if the verification information verifies that the user has the pre-set property, updating the recognition algorithm to reflect that the extracted feature indicates that the user has the pre-set property.

The above examples generally relate to updating recognition algorithms for biometric authentication, but the present disclosure is not limited to this particular example. Any form of recognition algorithm may be updated using the verification techniques disclosed herein. For example, the recognition algorithm may be arranged to recognise whether the user is fatigued, performing a certain activity like running or walking, dehydrated, or at risk of a medical emergency such as a heart attack. Of course other examples are within the scope of the present disclosure and are not limited to deriving health or fitness based insights. That is, the present disclosure provides a computer-implemented method of updating a recognition algorithm. The method comprises the following steps: obtaining a feature set extracted from sensor data sensed by one or more sensors of a wearable device; performing a recognition procedure to recognise whether the user wearing the wearable device has a pre-set property, the recognition procedure comprises inputting the extracted feature set to a recognition algorithm which uses the extracted feature set and a feature set determined to be associated with the pre-set property to generate a confidence level indicating the likelihood of the user having the pre-set property; obtaining verification information from the user wearing the wearable device to verify that the user has the pre-set property; and if the verification information verifies that the user has the pre-set property, updating the recognition algorithm to reflect that the extracted feature indicates that the user has the pre-set property.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer-implemented method of authenticating the identity of a user wearing a wearable device, the method comprises the following steps:
(a) obtaining a first source of authentication information for a user wearing the wearable device, wherein the first source of authentication information comprises a feature set extracted from biometric data sensed by one or more sensors of the wearable device;
(b) inputting the extracted feature set into a recognition algorithm which uses the extracted feature set and a predetermined feature set representing an authorised user that is authorised to use the wearable device, and generates a confidence level indicating the likelihood that the user wearing the wearable device is the authorised user;
(c) obtaining a second source of authentication information from the user of the wearable device;
(d) identifying, from the second source of authentication information, whether the user is authorised to use the wearable device; and
(e) if the user is identified as being authorised to use the wearable device from the second source of authentication information, authenticating the identity of the user wearing the wearable device as corresponding to the authorised user and updating the recognition algorithm to reflect that the extracted feature set represents the authorised user.

2. A method as claimed in claim 1, wherein if the user is identified as being authorised to use the wearable device from the first source of authentication information and the second source of authentication information, the method comprises authenticating the identity of the user wearing the wearable device.

3. A method as claimed in claim 1, wherein the recognition algorithm further comprises determining if the confidence level is greater than or equal to a predetermined threshold, and wherein steps (c) to (e) are performed if the generated confidence level is less than the predetermined threshold.

4. A method as claimed in claim 1, wherein updating the recognition algorithm comprises indicating to the recognition algorithm that the extracted feature set is associated with the authorised user.

5. A method as claimed in claim 4, wherein the indicating comprises adding the extracted feature set to a list of predetermined feature sets associated with the authorised user, optionally wherein the indicating comprises replacing the predetermined feature set with the extracted feature set such that in subsequent iterations of the recognition algorithm, the recognition algorithm uses the extracted feature set, optionally wherein the indicating comprises generating an updated feature set using a combination of the extracted feature set and the predetermined feature set.

6. A method as claimed in claim 1, wherein the recognition algorithm further comprises determining if the confidence level is greater than or equal to the predetermined threshold, and wherein updating the recognition algorithm further comprises modifying the predetermined threshold.

7. A method as claimed in claim 1, wherein the recognition algorithm inputs the extracted feature set to a machine-learned model which outputs the confidence level, wherein the machine-learned model is trained using training data comprising the predetermined feature set.

8. A method as claimed in claim 7, wherein step (e) further comprises updating the recognition algorithm to reflect that the extracted feature set represents the authorised user if the user is identified as being authorised to use the wearable device from the second source of authentication information, and wherein updating the recognition algorithm comprises training the machine-learned model using training data comprising the extracted feature set.

9. A method as claimed in claim 1, wherein step (c) comprises prompting the user of the wearable device to provide the second source of authentication information.

10. A method as claimed in claim 1, further comprising: obtaining an identifier for the wearable device.

11. A method as claimed in claim 10, wherein the recognition algorithm uses a predetermined feature set representing a user that is authorised to use the wearable device identified by the identifier.

12. A method as claimed in claim 1, wherein the recognition algorithm uses a plurality of predetermined feature sets representing a plurality of users that are authorised to use the wearable device, and generates a plurality of confidence levels each indicating the likelihood that the user wearing the wearable device is one the authorised users.

13. A method as claimed in claim 1, wherein the second source of authentication information is obtained from a separate device to the wearable device.

14. A method as claimed in claim 1, wherein the second source of authentication information is derived from one or more of a passcode, password, fingerprint ID, face ID, gesture, or user input.

15. A computer apparatus comprising:
a first obtaining module arranged to obtain a first source of authentication information for a user wearing a wearable device, wherein the first source of authentication information comprises a feature set extracted from biometric data sensed by one or more sensors of the wearable device;
a recognition module arranged to input the extracted feature set into a recognition algorithm which uses the extracted feature set and a predetermined feature set representing an authorised user that is authorised to use the wearable device, and generates a confidence level indicating the likelihood that the user wearing the wearable device is the authorised user; and
a second obtaining module arranged to:
obtain a second source of authentication information from the user of the wearable device;
identify, from the second source of authentication information, whether the user is authorised to use the wearable device; and
if the user is identified as being authorised to use the wearable device from the second source of authentication information, authenticate the identity of the user wearing the wearable device as corresponding to the authorised user and update the recognition algorithm to reflect that the extracted feature set represents the authorised user.
